(19) United States
(12) Patent Application Publication
(10) Pub. No.: US 2008/0225285 A1
(43) Pub. Date: Sep. 18, 2008

(54) Device for and Method of Measurement of Chemical Agents Quantity in Gas Medium

(76) Inventor: Mochkin V. Sergeevich, Moscow (RU)

Correspondence Address: UNITED STATES DEPARTMENT OF ENERGY, 1000 INDEPENDENCE AVENUE, S.W., ATTN: GC-62 (HQ) MS 6F-067, WASHINGTON, DC, 20585-0162, US

(21) Appl. No.: 12/046,063

(22) Filed: Mar. 11, 2008

(30) Foreign Application Priority Data
Mar. 12, 2007 (RU) 2007108973

(51) Int. Cl. G01J 3/00

(52) U.S. Cl. 356/300

(57) ABSTRACT

Measurement device for chemical agents quantity contained in a gas medium having a source of monochromatic radiation with a wavelength which changes in accordance with time law that is supplied through an optical brancher to an optical modulator, and then into a gas medium to be measured and further into a photoreceiver, whose signal is supplied into a computing block, while another part of the radiation from the optical brancher is supplied into a gas correlating filter, and the radiation which passed through the gas correlating filter is supplied to the auxiliary photoreceivers, whose signal is supplied to the solving block of standard comparison for controlling the optical modulator and the computing block, so that on the photoreceiver, a radiation is supplied only from spectral lines or bands of radiation of the chemical agents to be measured, and signals from a part of spectral radiation in spectral lines and bands which coincide with a spectral lines of bands of absorption of foreign gasses are filtered out.

### CROSS-REFERENCE TO A RELATED APPLICATION

The invention described and claimed hereinbelow is also described in Russian Patent Application RU 2007108973 filed on Mar. 12, 2007. This Russian Patent Application, whose subject matter is incorporated here by reference, provides the basis for a claim of priority of invention under 35 U.S.C. 119(a)-(d).

### BACKGROUND OF THE INVENTION

Certain previously known methods for chemical analysis of substances devices for measurements of chemical agent quantities which are contained in atmosphere and other gas media have limited sensitivity and selectivity.

A previously known device (See Drummond J. R. 1989: Novel Correlation radiometer: The Length-Modulated Radiometer. Appl. Opt. 28, 2451-2452) disadvantageously has the presence of mechanical movable elements, such as a mechanical modulator and its electric motor, worsens cost, mass-size, energy, service and reliability characteristics of the device. High values of selectivity and sensitivity of the method are not reached. In addition, the device has limitations of the method of gas-correlating radiometry-practical application for measurements of only agents with low molecular weight, having a linear spectrum of absorption.

Another device is disclosed in U.S. Pat. No. 5,128,797. In this device, extremely high values of selectivity and sensitivity of the method are not achieved, in particular because of the measurement of radiation in a whole working spectral range, as a result of which a signal from those parts of the spectrum in which there is a superposition of spectral components from lines of absorptions of the gas to be analyzed, for example butane and from “foreign” (background, not to be measured) gases, for example water is distorted. Also, this device has limitations of gas-correlating radiometry-practical applicability for measurements of only agents with low molecular weight, having a linear spectrum of absorption.

### SUMMARY OF THE INVENTION

Accordingly, it is an object of the present invention to provide a device for and measurement of chemical agent quantity contained in gas medium, which eliminates the disadvantages of the prior art.

More particularly, it is an object of the present invention to provide a device for measurement of chemical agent quantity in a gas medium which has increased sensitivity and selectivity of measurements of chemical agents quantity contained in a gas medium, and also an expanded area of use applicable to agents with higher molecular weight.

In keeping with these objects and with others which will become apparent hereinafter, one feature of the present invention resides, briefly stated, in a device for measurement of chemical agents quantity contained in gas medium, comprising a gas correlated filter with one or several gas vessels, with some vessels containing and other vessels not containing gasses with chemical agents to be measured; an optical modulator; photoreceiver; a computing block; a source of monochromatic radiation with a wavelength which changes in accordance with a time law; an optical brancher; a solving block of standard comparison; auxiliary photoreceivers, arranged so that a part of radiation from said source of monochromatic radiation with a wavelength which changes in accordance time law is supplied through said optical brancher to said optical modulator, and from said optical modulator is supplied into a gas medium to be measured and further into said photoreceiver, from which a signal is supplied into said computing block, while another part of the radiation from said optical brancher is supplied into said gas-correlating filter, so that the radiation which passed through said gas-correlating filter is supplied to said auxiliary photoreceivers, whose signal is supplied to said solving block of standard comparison for controlling said optical modulator and said computing block, so that on the photoreceiver a radiation is supplied only from spectral lines or bands of radiation of the chemical agents to be measured, and signals from a part of spectral radiation in spectral lines and bands which coincide with a spectral lines of bands of absorption of foreign gasses are filtered out.

Another feature of the present invention resides in a method for measurement of chemical agent quantity contained in gas medium, comprising a gas correlated filter with one or several gas vessels, with some vessels containing and other vessels not containing gasses with chemical agents to be measured; an optical modulator; photoreceiver; a computing block; a source of monochromatic radiation with a wavelength which changes in accordance with a time law; an optical brancher; a solving block of standard comparison; auxiliary photoreceivers, arranged so that a part of radiation from said source of monochromatic radiation with a wavelength which changes in accordance time law is supplied through said optical brancher to said optical modulator, and from said optical modulator is supplied into a gas medium to be measured and further into said photoreceiver, from which a signal is supplied into said computing block, while another part of the radiation from said optical brancher is supplied into said gas-correlating filter, so that the radiation which passed through said gas-correlating filter is supplied to said auxiliary photoreceivers, whose signal is supplied to said solving block of standard comparison for controlling said optical modulator and said computing block, so that on the photoreceiver a radiation is supplied only from spectral lines or bands of radiation of the chemical agents to be measured, and signals from a part of spectral radiation in spectral lines and bands which coincide with a spectral lines of bands of absorption of foreign gasses are filtered out.

The device in accordance with the present invention has a source of monochromatic radiation with a wavelength that changes in accordance with a time law, an optical branching element, a solving block allowing a sample comparison, and additional photo receivers, and also connections between them, wherein a part of radiation from the source of monochromatic radiation with a wavelength changing in accordance with the time law through the optical brancher is supplied to the optical modulator and from the optical modulator is supplied to a gas medium to be measured and further into the photoreceiver, a signal of which is supplied into a computing block, while another part of radiation from the optical branching element is supplied to a gas-correlating filter, the radiation which passed through the gas-correlating filter is supplied to additional photo receivers and solving block of the sample comparison for controlling the optical modulator and the computing block.

The radiation which pass through the gas medium and is partially absorbed by the chemical agent to be measured is directly absorbed in the photoreceiver without passing through the gas-correlating filter. The latter serves only for digital control of the optical modulator and the computing block, and does not introduce its error into the signal of the photoreceiver, so that the photo receiver receives the radiation only from the spectral lines or bands of absorption of chemical agents which are measured, while filtering out signals from the part of radiation spectrum in those spectral lines and bands which coincide with the spectral lines and bands of absorption of foreign (background, not to be measured) gasses.

With this use of the gas correlating filter it provides only a fixation of a current value of wavelength in the spectrum for the beginning and end of the operation of comparison by the solving block of the sample comparison, while the measurement with a higher sensitivity and accuracy is performed by the photoreceiver, since the signal from the gas-correlating filter is an effect of a second order from level of absorption.

In addition, in the present invention, the spectral lines and bands which coincide with analogous lines and bands of foreign gasses are excluded. The optical branching element allows to supply an identical (with the accuracy to a constant multiplier) in time and space radiation both in two photo receivers which measures absorption of radiation by the substance which is measured, and also into the gas-correlating filter. This excludes spectral and other errors, and there therefore provides high selectivity. As a result, an increase of sensitivity and selectivity of the measurements of quantity of chemical agents contained in the gas medium are increased, and also chemical agents with higher molecular weight can be measured.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings

### BRIEF DESCRIPTION OF THE DRAWINGS

FIG. 1 is a view schematically showing a device for measurements of chemical agent quantity contained in gas medium; and

FIG. 2 is a view illustrating selective absorption of radiation by vapors of analyzed agent.

### DESCRIPTION OF THE PREFERRED EMBODIMENTS

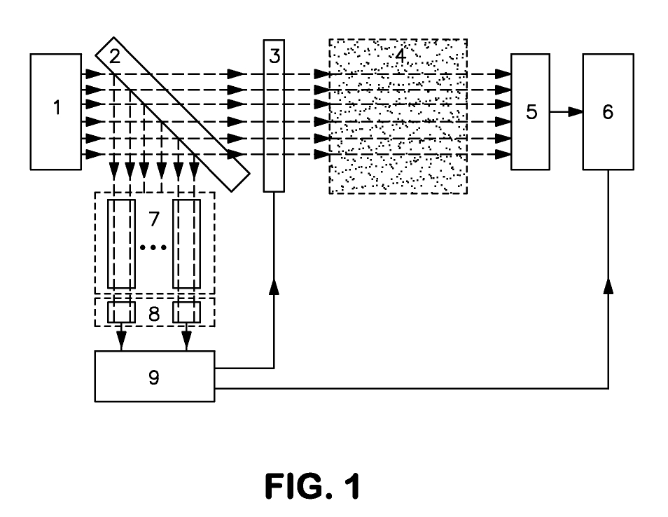

FIG. 1 shows a device for measurement of chemical agent quantity contained in gas medium, in accordance with the present invention. The device has a source of monochromatic radiation 1 with a wavelength changing in accordance with a time law, for example a semi-conductor laser diode with adjustable wavelength in a range of 1000-3000 nm, an optical branching element or brancher 2, for example a semi-transparent mirror, an optical modulator 3 which is an “open/close” key for example based on optical polarizers. Reference numeral 4 identifies a gas medium with measuring chemical agent, for example methane. The device has a photoreceiver 5, for example a photoresistor with elements which are focused on it, and a computing block 6, for example based on a microprocessor with an amplifier and an analog-digital converter.

It further has a gas-correlating filter 7 with gas cells. Some cells contain and other cells do not contain gas with the chemical agents to be measured (correlating gases, for example methane). The device has auxiliary photoreceivers 8, for example, analog photoreceivers, and a solving block of sample comparison 9, for example based on electronic comparitors of levels of signals.

The elements 1-9 separately are known and do not need additional explanation. Additional optical elements provided for filtering and focusing of radiation, for example lenses which are used in optical devices for focusing of radiation, light filters which are analogous to them are also known.

In simple case (when the requirements are not very high for parameters of the device), the optical modulator and brancher can be absent, and then their functions are realized by the remaining elements. For example, with sufficiently wide diagram of direction of the current source, a part of its side radiation can be supplied to the gas-correlating filter directly and therefore the optical brancher will not be needed, while errors of measurements due to angular non uniformity of radiation and other reasons can be minimized by calibration according to a standard.

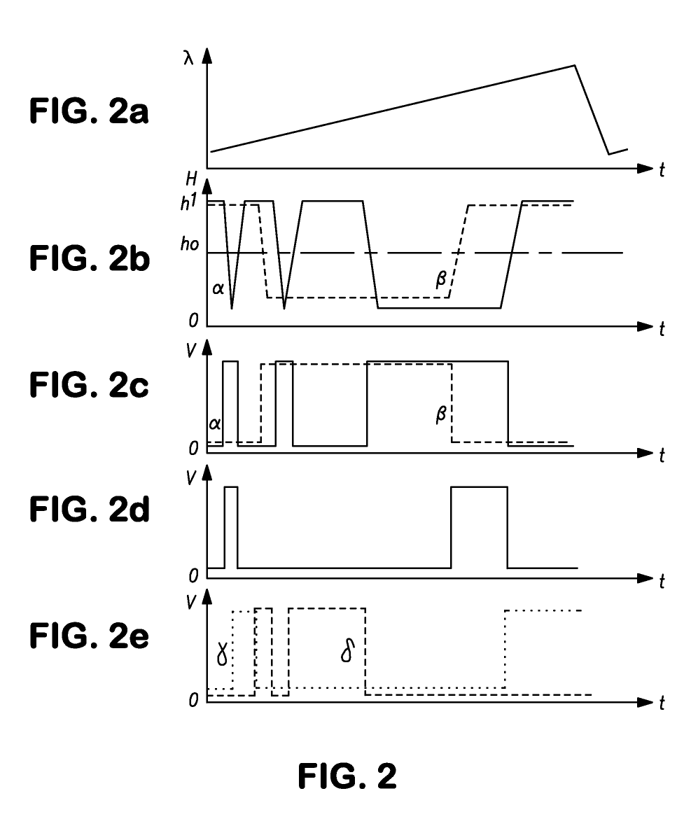

FIG. 2 shows time diagrams which schematically (in a simplified manner) illustrate processes in the proposed device. FIG. 2a shows a time dependence of a wavelength of radiation λ(t) for a specific case of a linear function in a working range FIG. 2b shows a dependency (hypothetical) of absorption of the radiation of a chemical agent to be measured (α) and background (β) as a function of wavelength of radiation in a current time; FIG. 2c shows a response of the solving block of analog comparison to the reaching of a level of absorption in the gas-correlating filter during comparison with a standard level (see, dash-dot line in FIG. 2b) for a chemical agent to be measured (α) and background (β). FIG. 2d shows a controlling signal which is supplied to the optical modulator and the computing block. FIG. 2e shows auxiliary signals which are produced by the solving block of standard comparison and supplied to the computing block.

The device in accordance with the invention operates and the inventive method is performed in the following manner.

A sufficiently intense pulse or continuous source of monochromatic radiation with a wavelength of radiation changing in time 1 in FIG. 1 generates a stream of radiation (light) with a spectrum which embraces a working range of wavelengths of the device. The wavelengths λ in time t is changed in the working range in accordance with linear (shown in FIG. 2a) or non-linear law. The radiation from it that passed through the optical brancher 2 and the modulator 3, passes through gas medium (artificial or natural atmosphere) 4, in which chemical agent to be measured, for example molecules of methane, are contained.

The auxiliary optical elements, for example lenses at the input of the receiving part of the device, not shown in FIG. 1, focus radiation and pass its part in a working range of the spectrum, for example with the use of light filters, to the photoreceiver 5, shown in FIG. 1. Parts of phatons of radiation is absorbed and dispersed by the measuring agent, while another part is absorbed and dispersed by “foreign” substances of gas medium, for example by vapors of water.

The picture of the process is also complicated due to influence of other factors (dispersion due to fluctuations of density of gas, over radiation of absorbed photons, etc.). Since the spectrum of absorption/radiation is individual for every agent, therefore by separating from the radiation which is applied to the device a part of radiation (with a spectrum corresponding to molecules of this agent) it is possible to determine a number of molecules of this agent in the selected column of a gas medium.

Conditionally, the spectral lines and bands of absorption of the agent to be measured (α) and of the background (β) are shown in FIG. 2b. For significant weakening of influence of foreign molecules of the gas medium, the modulator passes the radiation only of those wavelengths which are intensely absorbed by the agent to be measured and are almost not absorbed by vapors and gasses of foreign substances and background. This is performed by the gas correlating filter 7, into which a part of the radiation is branched by the optically brancher 2 (FIG. 1). The optical brancher 2 is composed of gas cells which contain correlating (and also measuring) gasses, for example methane, at a certain pressure. The element of comparison is also a cell which does not contain correlating gasses. For example, if any spectral line of the gas to be measured is measured is partially or completely overlapped by the spectral line of “foreign” molecules of agent of gas medium, and then it can lead to distortion of the output information signal and correspondingly to reduction of selectivity and sensitivity as in the prior art. In order to eliminate this effect, in the device in accordance with the present invention from the whole working spectral range, these spectral lines and bands are filtered out.

When the wavelength of radiation changes, as shown in FIG. 2, a selective absorption of radiation, which depends on time, by the vapors of the agent to be analyzed takes place in the area of its spectral lines and bands of absorption, for example 2b (α) and for agents and background 2b (β). In the solving block 9 a comparison of the level of signal from the auxiliary photoreceivers 8 is performed with the standard level hₒ as shown in FIG. 2b. When the standard level h₀ is reached, the solving block 9 supplies controlling signals V(α or β) shown in FIGS. 2c and d for opening (and then for closing) of the optical modulator (key) 3 and to the computing block 6 which carries processing, for example integration, of the signal from the photoreceiver 5. Analogously, as shown in FIG. 2e, supporting signals can be obtained for determination of initial level of radiation of source (γ) and absorption (δ), which is necessary for determination in the computing block of processing the signal of an absolute value of absorption by the chemical agent to be measured, and as a result of its content, (concentration) in the gas media.

For measurements of content of several gasses to be analyzed (measured chemical agents), into the gas cell 7 shown in FIG. 7 all corresponding correlation gasses are introduced, or several parallel acting gas cells with these gasses are used, for example when these gasses react with one another.

The processing of the signals in the working spectral range with consideration of filtered out spectral lines and bands by the computing block can be performed by known methods.

The device in accordance with the present invention allows to significantly exclude the influence of environment (temperature and pressure) instability of voltages of power supply and distortions (noises) and destabilizing factors, and also to filter out “bad” spectral lines and bands, which worsens selectivity and sensitivity of the device, and also to use it for the measurement of content in gas media of agents with higher molecular weight.

It will be understood that each of the elements described above, or two or more together, may also find a useful application in other types of constructions differing from the type described above.

While the invention has been illustrated and described as embodied in a device for measurement of chemical agent quantity contained in gas medium, it is not intended to be limited to the details shown, since various modifications and structural changes may be made without departing in any way from the spirit of the present invention.

1. A device for measurement of chemical agent quantity contained in gas medium, comprising a gas correlated filter with one or several gas vessels, with some vessels containing and other vessels not containing gasses with chemical agents to be measured; an optical modulator; a photoreceiver; a computing block; a source of monochromatic radiation with a wavelength which changes in accordance with a time law; an optical brancher; a solving block of standard comparison; auxiliary photoreceivers, arranged so that a part of radiation from said source of monochromatic radiation with a wavelength which changes in accordance time law is supplied through said optical brancher to said optical modulator, and from said optical modulator is supplied into a gas medium to be measured and further into said photoreceiver, from which a signal is supplied into said computing block, while another part of the radiation from said optical brancher is supplied into said gas-correlating filter, so that the radiation which passed through said gas-correlating filter is supplied to said auxiliary photoreceivers, whose signal is supplied to said solving block of standard comparison for controlling said optical modulator and said computing block, so that on the photoreceiver a radiation is supplied only from spectral lines or bands of radiation of the chemical agents to be measured, and signals from a part of spectral radiation in spectral lines and bands which coincide with a spectral lines of bands of absorption of foreign gasses are filtered out.

2. A method for measurement of chemical agent quantity contained in gas medium, comprising the steps of providing a gas correlated filter with one or several gas vessels, with some vessels containing and other vessels not containing gasses with chemical agents to be measured, an optical modulator, a photoreceiver, a computing block, a source of monochromatic radiation with a wavelength which changes in accordance with a time law, an optical brancher, a solving block of standard comparison, and auxiliary photoreceivers; supplying a part of radiation from said source of monochromatic radiation with a wavelength which changes in accordance time law through said optical brancher to said optical modulator, and from said optical modulator into a gas medium to be measured and further into said photoreceiver; supplying a signal from said photoreceiver into said computing block, while supplying another part of the radiation from said optical brancher into said gas-correlating filter, so that the radiation which passed through said gas-correlating filter is supplied to said auxiliary photoreceivers; supplying signal of said auxiliary photoreceivers fcto said solving block of standard comparison for controlling said optical modulator and said computing block, so that on the photoreceiver a radiation is supplied only from spectral lines or bands of radiation of the chemical agents to be measured, and signals from a part of spectral radiation in spectral lines and bands which coincide with a spectral lines of bands of absorption of foreign gasses are filtered out.
